(19) United States
(12) Patent Application Publication
(10) Pub. No.: US 2010/0078198 A1
(43) Pub. Date: Apr. 1, 2010

(54) High Gradient Multilayer Vacuum Insulator

(76) Inventors: John Richardson Harris, Patterson, CA (US); David M. Sandes, Livermore, CA (US); Steven A. Hawkins, Livermore, CA (US); Steven Falabella, Livermore, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(21) Appl. No.: 12/537,897

(22) Filed: Aug. 7, 2009

Related U.S. Application Data
(60) Provisional application No. 61/088,645, filed on Aug. 13, 2008.

(51) Int. Cl. H01B 17/42

(52) U.S. Cl. 174/140 R

(57) ABSTRACT

A high gradient multilayer vacuum insulator (HGI) with increased resistance to vacuum arcing to improve electrical strength. In an exemplary embodiment, the HGI includes a plurality of conductive and dielectric layers stacked in alternating arrangement so that the edges of the layers together form a vacuum-insulator interface and the stack has an overall length L_{S}. The dielectric layers each have a thickness I that is less than Iₜ

$${I}_{t} = {( \frac{{E}_{M}}{{E}_{BD}} )}^{2} {L}_{S}$$

where Iₜ is the transitional dielectric layer thickness below which failure of the vacuum insulator is by vacuum arcing, E_{BD} is the breakdown field required to initiate vacuum arcing across one of said dielectric layers, and E_{M} is the breakdown field required to initiate surface flashover across a monolithic dielectric material of length L_{S}.

### CLAIM OF PRIORITY IN PROVISIONAL APPLICATION

This application claims the benefit of U.S. Provisional Application No. 61/088,645 filed Aug. 13, 2008, entitled, “Improvements to Multilayer Vacuum Insulators” incorporated by reference herein.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to vacuum insulators and more particularly to high gradient multilayer vacuum insulators having adjacent layers with alternating relative permittivities (e.g. alternating dielectric and conductive layers) arranged or otherwise configured so as to exhibit high resistance to vacuum arcing.

### BACKGROUND OF THE INVENTION

Many electronic devices and systems depend on a pair of opposing high voltage electrodes separated by an insulator that is bounded by vacuum, i.e. a vacuum insulator. In particular, particle accelerators and pulsed-power systems require that a high-voltage pulse be transmitted across a vacuum-insulator interface, i.e. the surface region of the vacuum insulator between the electrodes that is exposed to vacuum. In order to produce such a pulse, the vacuum-insulator must have a high electrical strength, i.e. capable of withstanding applied high voltages without failure. This is particularly true of the dielectric wall accelerator (DWA) and related technologies.

A widely held view of the process by which a vacuum-insulator fails is that failure occurs not through the bulk insulator material but by vacuum surface flashover at the vacuum-insulator interface (see Reference 1) and believed to be initiated by secondary electron emission avalanche (SEEA) (see Reference 9). This view suggests that there is an enhancement of the electric field at triple points, e.g. points where there is an intersection of a vacuum, a solid insulator and an electrode. Electrons that are field emitted from a triple point on a cathode initially drift in the electric field between the end plates of the insulator which is a dielectric and is polarized when the emitted electrons impact the surface and knock loose additional electrons in a kind of chain reaction. This results in an electric field which further attracts additional electrons into the surface of the insulator. The electron collisions with the surface can liberate a greater number of electrons than originally collided with the surface, depending upon the electron energy of the collisions. This can lead to a catastrophic event in which the emission of these electrons further charges the insulator surface, leads to more collisions with the surface, and the release of even more electrons. This growing electron bombardment desorbs gas molecules that are stuck to the insulator surface and ionizes them, creating a dense plasma which then electrically shorts out the surface of the insulator between the electrodes, i.e. SEEA.

Furthermore, it is known that the electric field which can be sustained by an insulator scales as (length)^{-1/2} (see Reference 2). This suggests that insulators constructed from thin dielectric layers have increased voltage-holding capability compared to conventional monolithic dielectric insulators. In particular, it is known that multilayer vacuum insulating structures assembled from thin alternating layers of dielectric and conducting material are able to withstand high voltage better than conventional monolithic dielectric insulators of the same length, geometry, and dielectric material. These multilayer vacuum insulators are known interchangeably as high gradient insulators (HGI) or microstacks, and have been shown to withstand voltage gradients up to four times higher than conventional monolithic insulators of a similar shape (see Reference 3).

Despite the widely-reported improved performance associated with these HGI structures, however, the absence of good quantitative models describing HGI performance or the observed scaling of insulator strength with layer thickness have caused previous attempts at optimization to rely heavily on empirical studies. And despite promising results, this work led to different conclusions. For example, in Sampayan et al (Reference 3) 20,000 Å gold layers were sputtered on sub-millimeter silica layers treated with a final polishing operation and found improved results with thinner dielectric layers, in agreement with the length scaling for conventional insulators. And in Leopold et al (Reference 4), assemblies formed from Kovar (a registered trademark of Carpenter Technology Corporation) and alumina were used, with insulator thickness (I) and metal thickness (M) on the order of 1 mm, with I+M=4 mm, and with a surface polished to better than 0.1 μm. They found improved performance for I/M<3, which prevented the initiation of a secondary electron avalanche spanning multiple layers. And HGIs assembled from sub-millimeter sheets of dielectric and metal have been tested by Elizondo (Reference 5), Cravey et al (Reference 6), and Applicants (References 7, 8). These samples had metal layers which were nominally flush with the surface or protruding into the vacuum and generally showed improved performance as I/M increased. These empirical studies were intended to interrupt the secondary electron emission avalanche (SEEA) believed to initiate surface flashover at the vacuum-insulator interface rather than through the bulk material.

Due to the different conclusions produced by these studies, however, Applicants reexamined the failure mechanisms of HGIs in experiments performed at the Lawrence Livermore National Laboratory (see Summary section) in an effort to develop high gradient multilayer vacuum insulator designs that are based on a more accurate theory/mechanism of vacuum-insulator failure and not necessarily based on failure due to vacuum surface flashover.

### SUMMARY OF THE INVENTION

One aspect of the present invention includes a high gradient multilayer vacuum insulator comprising: a plurality of conductive and dielectric layers stacked in alternating arrangement so that the edges of said layers together form a vacuum-insulator interface and the stack has an overall length L_{S}, wherein said dielectric layers each have a thickness I that is less than Iₜ

$${I}_{t} = {( \frac{{E}_{M}}{{E}_{BD}} )}^{2} {L}_{S}$$

where Iₜ is the transitional dielectric layer thickness below which failure of the vacuum insulator is by vacuum arcing, E_{BD} is the breakdown field required to initiate vacuum arcing across one of said dielectric layers, and E_{M} is the breakdown field required to initiate surface flashover across a monolithic dielectric material of length L_{S}.

Another aspect of the present invention includes a high gradient multilayer vacuum insulator comprising: a plurality of conductive-material-coated dielectric layers stacked in alternating conductive-dielectric arrangement so that the edges of said layers together form a vacuum-insulator interface and the stack has an overall length L_{S}, wherein the dielectric sections of said conductive-material-coated dielectric layers each have a thickness I that is less than Iₜ

$${I}_{t} = {( \frac{{E}_{M}}{{E}_{BD}} )}^{2} {L}_{S}$$

where Iₜ is the transitional dielectric layer thickness below which failure of the vacuum insulator is by vacuum arcing, E_{BD} is the breakdown field required to initiate vacuum arcing across one of said dielectric layers, and E_{M} is the breakdown field required to initiate surface flashover across a monolithic dielectric material of length L_{S}.

Another aspect of the present invention includes a high gradient multilayer vacuum insulator comprising: a plurality of dielectric layers characterized by one of a lower relative permittivity and a higher relative permittivity and stacked in alternating arrangement so that the edges of said layers together form a vacuum-insulator interface.

Another aspect of the present invention includes a high gradient multilayer vacuum insulator comprising: a plurality of semi-conductor and dielectric layers characterized by a lower relative permittivity and a higher relative permittivity, respectively, and stacked in alternating arrangement so that the edges of said layers together form a vacuum-insulator interface.

Another aspect of the present invention includes a high gradient multilayer vacuum insulator comprising: a dielectric cylinder having a curvilinear side surface which is a vacuum-insulator interface with grooves formed thereon in a direction substantially parallel to the cylinder ends to produce alternating grooves and lands with the lands having a higher relative permittivity than the space within the grooves.

Another aspect of the present invention includes a high gradient multilayer vacuum insulator comprising: a plurality of dielectric layers in stacked arrangement so that the edges of said layers together form a vacuum-insulator interface and outer edge surfaces of a first set of alternating layers are recessed from outer edge surfaces of a second set of alternating layers.

Generally, the present invention is directed to various high gradient multilayer vacuum insulator configurations and approaches which improve the electrical strength of the multilayer vacuum insulator by arranging the dielectric and conductive layers in a manner which increases the vacuum insulator's resistance to vacuum arcing, i.e. has a higher vacuum arcing threshold.

For example, some exemplary embodiments of the high gradient multilayer vacuum insulator construction having increased resistance to vacuum arcing may (1) have dielectric layers each having a thickness I that is less than Iₜ

$${I}_{t} = {( \frac{{E}_{M}}{{E}_{BD}} )}^{2} {L}_{S}$$

where Iₜ is the transitional dielectric layer thickness below which failure of the vacuum insulator is by vacuum arcing, L_{S} is the overall length of the stack, E_{BD} is the breakdown field required to initiate vacuum arcing across one of said dielectric layers, and E_{M} is the breakdown field required to initiate surface flashover across a monolithic dielectric material of length L_{S}. In addition, the high gradient multilayer vacuum insulator construction of the present invention may (2) use conductive layers (e.g. metals) which are known in the literature to have high resistance to vacuum arcing due to their high vacuum breakdown field, or (3) use conductive layers treated by electropolishing prior to assembly, or (4) use conductive layers known in the literature to have a high work function greater than about 4.5, or (5) use conductive layers coated with a second material (e.g. metal, dielectric, semi-conductor) prior to assembly in order to increase the vacuum arc threshold field, or (6) use conductive-material-coated dielectric layers in stacked arrangement, where the dielectric layers are coated prior to assembly, or (7) use conductive layers where the outer edge surfaces thereof are recessed below the outer edge surfaces of the dielectric layers so that there is no line of sight between adjacent conductive layers.

Other exemplary embodiments of the high gradient multilayer vacuum insulator construction having increased resistance to vacuum arcing may not use conductive (e.g. metal) layers, but instead use other materials in lieu thereof, such as a dielectric layer with increased conductivity or a semi-conductor layer.

Furthermore, in an attempt to prevent vacuum arcing altogether, still other exemplary embodiments of the present invention may include (1) a high gradient insulator having sides in which grooves are formed and occupied by vacuum, or (2) a stack of dielectric layers arranged so that alternating “lands” and “grooves” are formed at the vacuum-insulator interface to distort the equipotentials around the insulator. In all of the exemplary stacked embodiments, the plurality of layers is stacked so that the edges of the layers together form the vacuum-insulator interface. And it is appreciated that the layer edges, and in particular the outer edge surfaces, are the radially outermost portions of the layers.

In experiments performed by Applicants at the Lawrence Livermore National Laboratory, two failure mechanisms were considered, both of which are known to explain the experimental data currently available: one assuming failure by vacuum surface flashover along the dielectric layer, and one assuming failure by vacuum arcing between adjacent metal layers. It has been determined that of these two mechanisms, the upper limit on the strength of a multilayer vacuum insulator is not set by the surface flashover strength of the individual dielectric layers, but is rather set by the vacuum arc strength between adjacent metal layers, which was not considered previously. The variation of insulator electrical strength as a function of insulator and metal thickness which is predicted by theory is in good agreement with the experimental evidence currently available.

The following is a description of the experiments performed by Applicants which suggests that HGI failure dominated by the vacuum arc strength between adjacent metal layers. Samples used for the experiments were machined from sheets of Rexolite (a registered trademark of C-Lec Plastics Company) and stainless steel laminations. Surface measurements showed that the metal layers protruded beyond the dielectric layers by 10 μm, likely due to thermal expansion of the Rexolite during machining. Although simulations indicated that this protrusion would not significantly alter electron trajectories near the surface, it did provide a direct line of sight between adjacent metal layers. HGIs examined before testing showed ragged micro-protrusions on the metal layers, also believed to be an artifact of the machining process (FIG. 1). In FIG. 1, frame (a) shows a typical discharge event, frame (b) shows a vertical white streak containing chromium and region of ablation, frame (c) shows a typical stainless steel layer before testing, and frame (d) shows a typical stainless steel layer after testing. Discharge events during high-voltage testing consisted of many small discharges between adjacent metal layers, often widely scattered over the HOT surface. At locations where discharges were particularly prominent, the metal layers were eroded, with a surface structure suggesting the melting and rapid refreezing of the metal, and white material was deposited in streaks consistent with the shape of the discharges. Energy-dispersive x-ray measurements detected chromium in these streaks, confirming that they were formed by the ablation and re-deposition of the stainless steel layers.

These results suggested that the insulators might be failing by vacuum arcing between adjacent metal layers rather than surface flashover of the dielectric layers. For small vacuum gaps and relatively high fields, the electric field E_{BD} needed to initiate a vacuum arc is generally found to be independent of vacuum gap length (see Reference 10). Consider an HGI made of alternating layers of metal and dielectric, where each period is identical and there is no interlayer coupling, as shown in FIG. 2. In particular, FIG. 2 shows the HGI having overall length L_{S}, dielectric layer thickness I, metal thickness M, overhanging metal layers (10), dielectric layers (12), upper pulsed electrode, and lower grounded electrode. The voltage held across each dielectric layer will be E_{BD}I, and the voltage held by a stack with N periods will be E_{BD}IN. The structure length L_{S} is related to the number of periods by

L_{S}=N(I+M)

so the average electric field held by the HGI is

$${E}_{EGI} = \frac{{E}_{BD}}{1 + {( \frac{I}{M} )}^{- 1}} \qquad Eq . ( 1 )$$

This formula is in good agreement with our results (FIG. 3) and those of Elizondo (FIG. 4) and agrees qualitatively with those of Cravey et al. In particular, FIG. 3 shows the results from testing by Applicants of Rexolite and stainless steel HGIs as described in Reference 8, compared to Eq. (1) with E_{BD} equal to 24 MV/m. A single data point at I/M equal to 40 was rejected because that sample was damaged prior to testing. And FIG. 4 shows Elizondo's data (Reference 5) for Mylar and stainless steel HGIs with metal layers protruding by 40 mils, from Reference 5, compared to Eq. (1) with E_{BD} equal to 28.7 MV/m. Because E_{BD} was not measured in these experiments, we treat it as a fitting constant. Values of E_{BD} inferred from these experiments are less than the enhanced, microscopic threshold field for stainless steel by a factor of approximately 300, an enhancement factor consistent with those reported in the literature (see Reference 11).

In each of these experiments, structure performance was generally seen to increase with I/M, as predicted by Eq. (1). This differs from the scaling seen by Sampayan et al. and Leopold et al., whose HGI configurations avoided a direct line of sight between metal layers. If we repeat the derivation of Eq. (1) but assume the I^{-1/2} scaling for surface flashover, the HGI strength becomes

$${E}_{EGI} = {E}_{m} \sqrt{{L}_{s}} \frac{\sqrt{I}}{I + M} \qquad Eq . ( 2 )$$

where the dielectric material has a breakdown field E_{M} when tested with a sample of length L_{S}. In the experiments of Leopold et al., I+M was held constant, E_{M} equal to 5.1 MV/m, and L_{S} equal to 16 mm. The HGI electrical strength calculated from Eq. (2) agrees to within 15% of the experimental results of Leopold et al. for HGI configurations with I/M less than 3 (FIG. 5). FIG. 5 shows Leopold's data (Reference 4) for Kovar and alumina HGIs (×) plotted against Eq. (2) with E_{M} equal to 5.1 MV/m, L_{S} equal to 16 mm, and I+M equal to 4 mm (+). The dashed line represents the strength of the conventional insulator (E_{M}). Shading represents the region of interlayer coupling, which violates an assumption used to derive Eq. (2). Note the good agreement when there is no interlayer coupling. Note also that when Leopold et al. tested a sample with I equal to 0.97 mm and M equal to 3.03 mm, they found that the HGI held 5.1 MV/m, identical to the strength of a monolithic insulator of the same size and using the same dielectric material. This is explained by Eq. (2), which predicts E_{HGI} equal to E_{M} when

\sqrt{L_{S}I}=I+M.

For I/M greater than 3, Leopold et al. showed the existence of a secondary electron avalanche spanning multiple periods, which establishes interlayer coupling and violates an assumption used to derive Eq. (2).

Equations (1) and (2) predict that when both failure modes are allowed, surface flashover will dominate for thicker dielectric layers and vacuum arcing will dominate for thinner dielectric layers. For a given I/M, the HGI electrical strength will initially increase as I is made smaller until the transition to failure by vacuum arc occurs, after which it will remain constant. This transition is determined by

$${I}_{t} = {( \frac{{E}_{M}}{{E}_{BD}} )}^{2} {L}_{S} \qquad Eq . ( 3 )$$

The model described in these experiments can be summarized as follows. When HGIs have metal layers protruding into the vacuum, both surface flashover and vacuum arcing are potential failure mechanisms. The surface flashover strength associated with a dielectric layer increases as its thickness is made smaller while its vacuum arc strength remains constant, so that flashover will dominate for large thicknesses and vacuum arcing will dominate for small thicknesses. In each regime, the electrical strength of the HGI can be calculated by simple equations which rely on measurable material parameters and on known scaling laws for the two discharge types. These models only hold in the absence of interlayer coupling but are otherwise in good agreement with the experimental data currently available. When vacuum arcing is a potential failure mechanism, it establishes the upper limit on HGI electrical strength that can be achieved with given materials. Therefore, improved HGI designs of the present invention seek to overcome this by increasing the breakdown field E_{BD} and thereby increase resistance to vacuum arcing. This enables performance of the HGI to be further improved by enabling the use of even thinner dielectric layers.

### BRIEF DESCRIPTION OF THE DRAWINGS

The accompanying drawings, which are incorporated into and form a part of the disclosure, are as follows:

FIG. 1 shows experimental photos of HGI discharge and damage.

FIG. 2 is a schematic view of an idealized HGI configuration used to derive Eqs. (1) and (2).

FIG. 3 is a graph showing results from testing by Applicants of Rexolite and stainless steel HGIs as described in Reference 8, compared to Eq. (1) with E_{BD} equal to 24 MV/m.

FIG. 4 is Elizondo's data (Reference 5) for Mylar and stainless steel HGIs with metal layers protruding by 40 mils, from Reference 5, compared to Eq. (1) with E_{BD} equal to 28.7 MV/m.

FIG. 5 is a graph showing Leopold's data (Reference 4) for Kovar and alumina HGIs (×) plotted against Eq. (2) with E_{M} equal to 5.1 MV/m, L_{S} equal to 16 mm, and I+M equal to 4 mm (+).

FIG. 6 is a schematic view of an exemplary embodiment of the present invention showing that the insulator layer thickness I is less than Iₜ where

$${I}_{t} = {( \frac{{E}_{M}}{{E}_{BD}} )}^{2} {L}_{S} .$$

FIG. 7 is an exploded schematic view of another exemplary embodiment of the present invention showing that the conductor layers are coated with a second material prior to assembly.

FIG. 8 is a schematic view of another exemplary embodiment of the present invention showing that the outer edge surfaces of the conductive layers recessed from the outer edge surfaces of the dielectric layers.

FIG. 9 is an exploded schematic view of another exemplary embodiment of the present invention showing a plurality of conductive-material-coated dielectric layers stacked in alternative conductive-dielectric arrangement.

FIG. 10 is a schematic view of another exemplary embodiment of the present invention showing a plurality of dielectric layers characterized by one of a lower relative permittivity material and a higher relative permittivity material in alternating arrangement.

FIG. 11 is a schematic view of another exemplary embodiment of the present invention showing a dielectric cylinder having grooves formed on a curvilinear surface to form lands and grooves on the vacuum-insulator interface.

FIG. 12 is a schematic view of another exemplary embodiment of the present invention showing a plurality of cylinder layers stacked to form alternating lands and grooves on the vacuum-insulator interface.

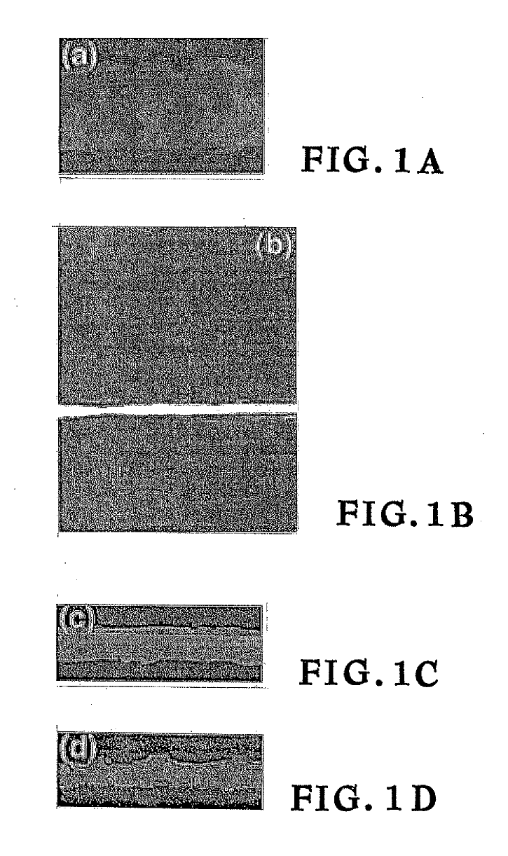

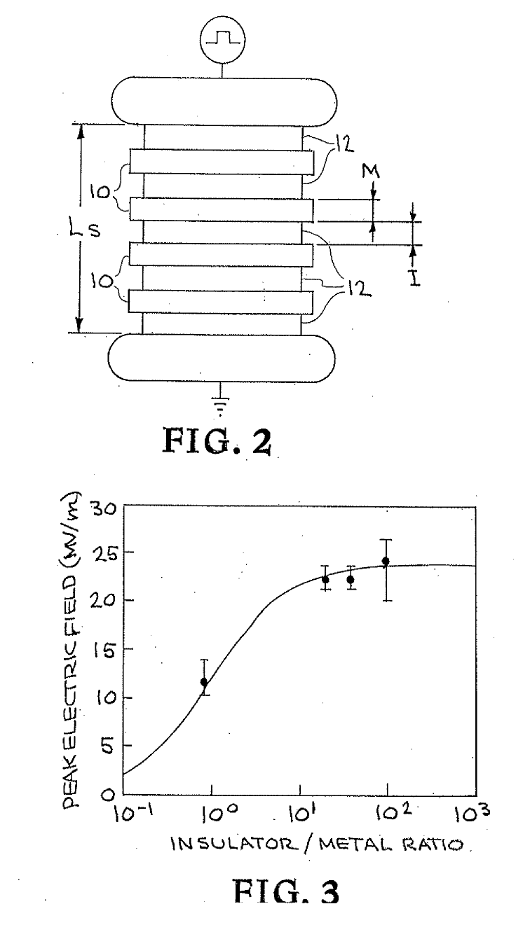

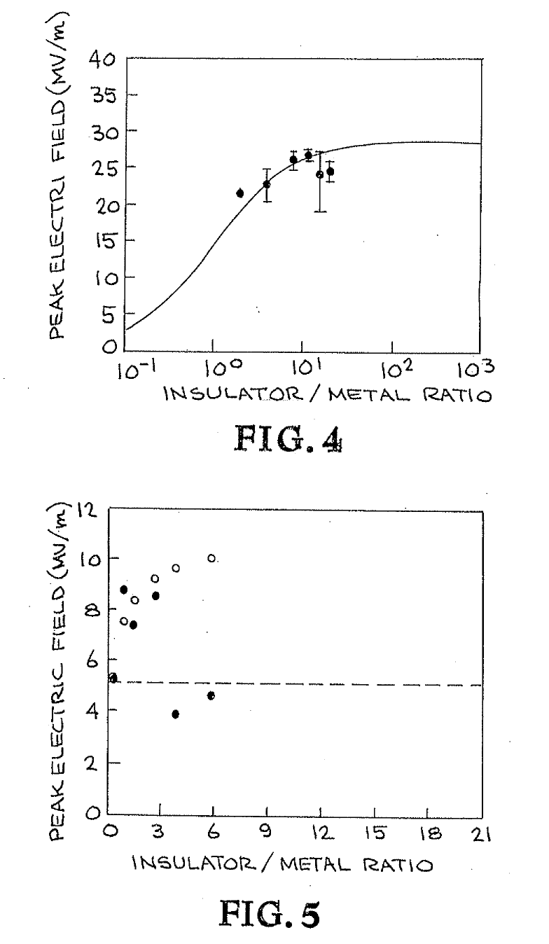

### DETAILED DESCRIPTION

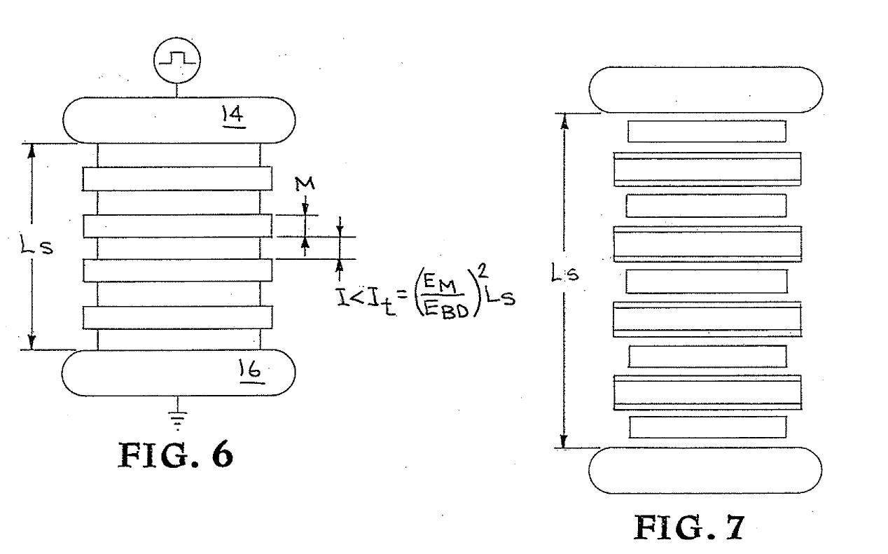

Turning now to the drawings, FIG. 6 shows a first exemplary embodiment of the high gradient multilayer vacuum insulator (abbreviated as “HGI”) of the present invention, and shown between two electrodes (shown as 14 and 16 at top and bottom ends, respectively). The HGI is shown comprising a plurality of conductive and dielectric layers stacked in alternating arrangement so that the edges of said layers together form a vacuum-insulator interface and the stack has an overall length L_{S}. The conductive layer is preferably a metal layer having thickness M. Furthermore, the dielectric layers each have a thickness I that is less than Iₜ

$${I}_{t} = {( \frac{{E}_{M}}{{E}_{BD}} )}^{2} {L}_{S}$$

where Iₜ is the transitional dielectric layer thickness below which failure of the vacuum insulator is by vacuum arcing, E_{BD} is the breakdown field required to initiate vacuum arcing across one of said dielectric layers, and E_{M} is the breakdown field required to initiate surface flashover across a monolithic dielectric material of length L_{S}. It is notable that (Eₘ)²L_{S} is a material constant related to the surface flashover strength of the dielectric. As mentioned in the Summary section, by choosing insulator thickness I to be less than Iₜ, of Eq. (1) above, the dominant HGI failure mechanism is vacuum arcing. Since the vacuum arc onset occurs as the dielectric layer thickness is made smaller, this effect provides a cap on the performance improvement that can be gained by reducing the thickness of the dielectric layers. There are therefore various additional approaches which may be employed to overcome this cap by increasing the breakdown field E_{BD}. Though not shown in the drawings, in another exemplary embodiment, the conductive layers may be of a type having a high E_{BD} breakdown field that enables thinner dielectric layers of thickness I that is resistant to vacuum arcing at the vacuum-insulator interface. For example, the conductive layers of the type having a high E_{BD} breakdown field may be selected from a group consisting of tungsten, molybdenum, nickel, zirconium, aluminum, titanium, tantalum, cadmium, platinum, and alloys thereof. The dielectric layers and other typical HGI design considerations may be chosen from those known and used in the art for HGIs, as described in U.S. Pat. No. 6,331,194, incorporated by reference herein. It is appreciated that in standard conditions at atmospheric pressure, gas serves as an excellent insulator, requiring the application of a significant voltage before breaking down. In vacuum, this breakdown potential may decrease to an extent that two un-insulated surfaces with different potentials might induce the electrical breakdown of the surrounding gas, and may damage an apparatus. The breakdown voltage in vacuum is generally represented as

$${V}_{b} = \frac{Bpd}{ln Apd - ln [ 1 + \frac{1}{{γ}_{se}} ]}$$

where V_{b} is the breakdown potential in volts, A and B are constants that depend on the surrounding gas, p represents the pressure of the surrounding gas, d represents the distance in centimeters between the conducting layers, and γₛₑ represents the secondary electron emission coefficient.

Another exemplary embodiment of the high gradient multilayer vacuum insulator of claim 1, though not shown in the drawings, is to use conductive layers which are electropolished prior to assembly to reduce the number of field enhancement sites and thereby increase resistance to vacuum arcing at the vacuum-insulator interface.

Another exemplary embodiment of the high gradient multilayer vacuum insulator of claim 1, though not shown in the drawings, is to use conductive layers which are of a type having a high work function greater than about 4.0 eV to increase resistance to vacuum arcing at the vacuum-insulator interface. For example, the high work function conductive layers may be selected from a group consisting of tungsten, selenium, platinum, nickel, iridium, germanium, cobalt, and alloys thereof. It is appreciated that the work function is the minimum energy (usually measured in electron volts) needed to remove an electron a solid to a point immediately outside the solid surface (or energy needed to move an electron from the Fermi energy level into vacuum).

FIG. 7 shows another exemplary embodiment of the high gradient multilayer vacuum insulator where the conductive layers are coated with a second material prior to assembly. The second material may be chosen from a group consisting of conductor, dielectric, and semiconductor of a type having a high E_{BD} breakdown field that enables thinner dielectric layers of thickness I that is resistant to vacuum arcing at the vacuum-insulator interface.

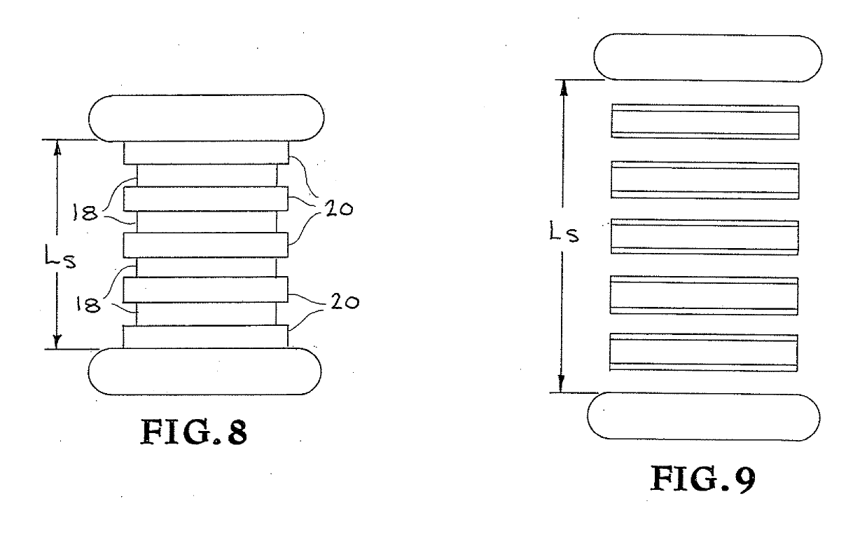

FIG. 8 shows another exemplary embodiment of the high gradient multilayer vacuum insulator where the outer edge surfaces of the conductive layers (18) are recessed from outer edge surfaces of said dielectric layers (20), so that there is no direct line of sight between conductive layers. Techniques for producing this arrangement include, but are not limited to: (1) exposing the HGI to a liquid or gas chosen to preferentially etch back the metal, and (2) machining of the HGI surface to remove the metal layers (and possibly adjacent regions of the dielectric layers).

FIG. 9 shows another exemplary embodiment of the high gradient multilayer vacuum insulator having a plurality of conductive-material-coated dielectric layers stacked in alternating conductive-dielectric arrangement so that the edges of said layers together form a vacuum-insulator interface and the stack has an overall length L_{S}. The dielectric sections of said conductive-material-coated dielectric layers each have a thickness I that is less than Iₜ

$${I}_{t} = {( \frac{{E}_{M}}{{E}_{BD}} )}^{2} {L}_{S}$$

where Iₜ is the transitional dielectric layer thickness below which failure of the vacuum insulator is by vacuum arcing, E_{BD} is the breakdown field required to initiate vacuum arcing across one of said dielectric layers, and E_{M} is the breakdown field required to initiate surface flashover across a monolithic dielectric material of length L_{S}. It is notable that the high gradient multilayer vacuum insulator may be selected from a group consisting of tungsten, selenium, platinum, nickel, iridium, germanium, cobalt, molybdenum, zirconium, aluminum, titanium, tantalum, cadmium, and alloys thereof.

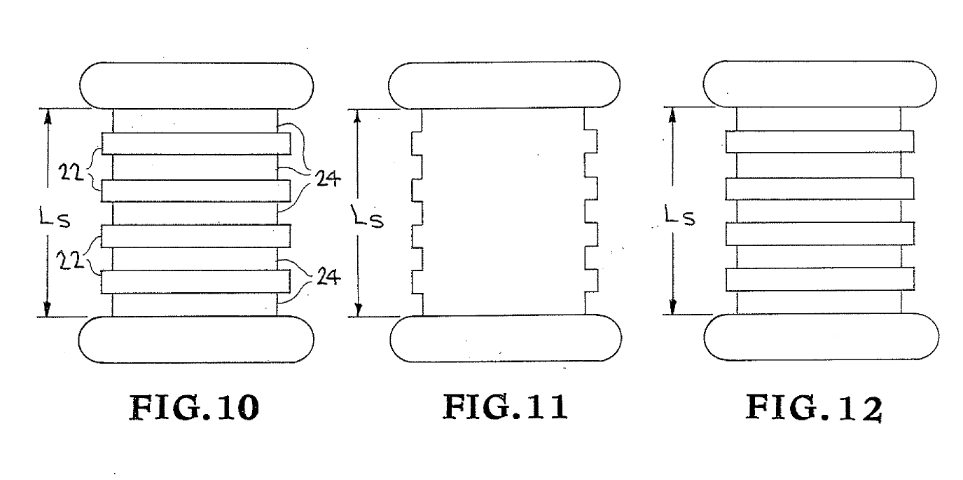

FIG. 10 shows another exemplary embodiment of the high gradient multilayer vacuum insulator having a plurality of dielectric layers characterized by one of a lower relative permittivity and a higher relative permittivity and stacked in alternating arrangement so that the edges of said layers together form a vacuum-insulator interface. In this arrangement dielectric layers are used in lieu of metal. For example, conductive Kapton layers (22) (a registered trademark of DuPont) may be used in alternating arrangement with non-conductive dielectric layers (24). This approach is intended to eliminate the possibility of vacuum arc between adjacent metal layers by eliminating the metal layers themselves. In the alternative, the high gradient multilayer vacuum insulator may have a plurality of semi-conductor and dielectric layers characterized by a lower relative permittivity and a higher relative permittivity, respectively, and stacked in alternating arrangement so that the edges of the layers together form a vacuum-insulator interface. The layers (22) in FIG. 10 may in the alternative be considered as the semi-conductor layers.

FIG. 11 shows another exemplary embodiment of the high gradient multilayer vacuum insulator having a dielectric cylinder having a curvilinear side surface which is a vacuum-insulator interface with grooves formed on it. In particular, the grooves are formed in a direction substantially parallel to the cylinder ends to produce alternating grooves and lands with the lands having a higher relative permittivity than the space within the grooves. Preferably in an exemplary embodiment, the grooves and the lands have a 1:1 packing factor. And in another exemplary embodiment, the grooves may be formed continuously on the curvilinear side surface. From an electrical standpoint, the vacuum and the grooves will have a relative permittivity of 1, while the dielectric and the lands will have a higher relative permittivity. The result is that the lands will tend to “buck out” the potential lines, a distortion which is similar to that demonstrated by Leopold (Reference 4) with dielectric/metal HGIs. This distortion will result in electric fields which can deflect electrons away from the insulator surface, and therefore should improve the insulator's resistance to vacuum surface flashover.

FIG. 12 shows another exemplary embodiment of the high gradient multilayer vacuum insulator having a plurality of dielectric layers in stacked arrangement so that the edges of the layers together form a vacuum-insulator interface and outer edge surfaces of a first set of alternating layers are recessed from outer edge surfaces of a second set of alternating layers. The embodiment of FIG. 12 can produce the same result of FIG. 11 by stacking alternating layers of different relative permittivities. Such structures would not in general require flush surfaces, and could have some dielectric layers protruding above others. Such structures could be assembled by conventional means, such as stacking thin layers of different dielectrics with adhesive layers in between. Alternatively, they could be assembled by depositing a layer of dielectric material in a liquid state, which then solidifies, after which the next layer could be deposited, and so forth.

Although particular embodiments of the present invention have been described and illustrated, such is not intended to limit the invention. Modifications and changes will no doubt become apparent to those skilled in the art, and it is intended that the invention only be limited by the scope of the appended claims.

### REFERENCES

1. H. Craig Miller, IEEE Trans. Electr. Insul. 24, 765 (1989).
2. A. S. Pillai and R. Hackam, J. Appl. Phys. 58, 146 (1985).
3. S. E. Sampayan, P. A. Vitello, M. L. Krogh, and J. M. Elizondo, IEEE Trans. Dielectr. Electr. Insul. 7, 334 (2000).
4. J. G. Leopold, U. Dai, Y. Finkelstein, E. Weissman, and S. Humphries, IEEE Trans. Dielectr. Electr. Insul. 12, 530 (2005).
5. J. M. Elizondo, “Microstack insulator for flashover inhibition: Phase II,” Defense Nuclear Agency Technical Report No. DNA-TR-91-86, 1992.
6. W. R. Cravey, G. L. Devlin, C. S. Mayberry, and J. N. Downing, 1997 IEEE International Pulsed Power Conference, Digest of Technical Papers, 2, 555-558 (1997).
7. J. R. Harris, R. M. Anaya, D. Blackfield, Y.-J. Chen, S. Falabella, S. Hawkins, C. Holmes, A. C. Paul, S. Sampayan, D. M. Sanders, J. A. Watson, G. J. Caporaso, and M. Krogh, IEEE Trans. Dielectr. Electr. Insul. 14, 767 (2006).
8. J. R. Harris, D. Blackfield, G. J. Caporaso, Y.-J. Chen, S. Hawkins, M. Kendig, B. Poole, D. M. Sanders, M. Krogh, and J. E. Managan, J. Appl. Phys. 104, 023301 (2008).
9. R. A. Anderson, Appl. Phys. Lett. 24, 54 (1974).
10. G. A. Mesyats and D. I. Proskurovsky, Pulsed Electrical Discharge in Vacuum (Springer, Berlin, 1989), Sec. 2.2.3.
11. P. Kranjec and L. Ruby, J. Vac. Sci. Technol. 4, 94 (1967).

1. A high gradient multilayer vacuum insulator comprising:
a plurality of conductive and dielectric layers stacked in alternating arrangement so that the edges of said layers together form a vacuum-insulator interface and the stack has an overall length L_{S}, wherein said dielectric layers each have a thickness I that is less than Iₜ
$${I}_{t} = {( \frac{{E}_{M}}{{E}_{BD}} )}^{2} {L}_{S}$$
where Iₜ is the transitional dielectric layer thickness below which failure of the vacuum insulator is by vacuum arcing, E_{BD} is the breakdown field required to initiate vacuum arcing across one of said dielectric layers, and E_{M} is the breakdown field required to initiate surface flashover across a monolithic dielectric material of length L_{S}.

2. The high gradient multilayer vacuum insulator of claim 1,
wherein said conductive layers are of a type having a high E_{BD} breakdown field that enables thinner dielectric layers of thickness I that is resistant to vacuum arcing at the vacuum-insulator interface.

3. The high gradient multilayer vacuum insulator of claim 2,
wherein said conductive layers of the type having a high E_{BD} breakdown field and selected from a group consisting of tungsten, molybdenum, nickel, zirconium, aluminum, titanium, tantalum, cadmium, platinum, and alloys thereof.

4. The high gradient multilayer vacuum insulator of claim 1,
wherein said conductive layers are electropolished prior to assembly to reduce the number of field enhancement sites and thereby increase resistance to vacuum arcing at the vacuum-insulator interface.

5. The high gradient multilayer vacuum insulator of claim 1,
wherein said conductive layers are of a type having a high work function greater than about 4.0 eV to increase resistance to vacuum arcing at the vacuum-insulator interface.

6. The high gradient multilayer vacuum insulator of claim 5,
wherein said conductive layers of the type having a high work function greater than about 4.0 eV are selected from a group consisting of tungsten, selenium, platinum, nickel, iridium, germanium, cobalt, and alloys thereof.

7. The high gradient multilayer vacuum insulator of claim 1,
wherein said conductive layers are coated with a second material prior to assembly, said second material chosen from a group consisting of conductor, dielectric, and semiconductor of a type having a high E_{BD} breakdown field that enables thinner dielectric layers of thickness I that is resistant to vacuum arcing at the vacuum-insulator interface.

8. The high gradient multilayer vacuum insulator of claim 1,
wherein outer edge surfaces of said conductive layers are recessed from outer edge surfaces of said dielectric layers.

9. A high gradient multilayer vacuum insulator comprising:
a plurality of conductive-material-coated dielectric layers stacked in alternating conductive-dielectric arrangement so that the edges of said layers together form a vacuum-insulator interface and the stack has an overall length L_{S}, wherein the dielectric sections of said conductive-material-coated dielectric layers each have a thickness I that is less than Iₜ
$${I}_{t} = {( \frac{{E}_{M}}{{E}_{BD}} )}^{2} {L}_{S}$$
where Iₜ is the transitional dielectric layer thickness below which failure of the vacuum insulator is by vacuum arcing, E_{BD} is the breakdown field required to initiate vacuum arcing across one of said dielectric layers, and E_{M}, is the breakdown field required to initiate surface flashover across a monolithic dielectric material of length L_{S}.

10. The high gradient multilayer vacuum insulator of claim 9,
wherein said conductive-material coating is selected from a group consisting of tungsten, selenium, platinum, nickel, iridium, germanium, cobalt, molybdenum, zirconium, aluminum, titanium, tantalum, cadmium, and alloys thereof.

11. A high gradient multilayer vacuum insulator comprising:
a plurality of semi-conductor and dielectric layers characterized by a lower relative permittivity and a higher relative permittivity, respectively, and stacked in alternating arrangement so that the edges of said layers together form a vacuum-insulator interface and the stack has an overall length L_{S}, wherein the dielectric layers each have a thickness I that is less than Iₜ
$${I}_{t} = {( \frac{{E}_{M}}{{E}_{BD}} )}^{2} {L}_{S}$$
where Iₜ is the transitional dielectric layer thickness below which failure of the vacuum insulator is by vacuum arcing, E_{BD} is the breakdown field required to initiate vacuum arcing across one of said dielectric layers, and E_{M} is the breakdown field required to initiate surface flashover across a monolithic dielectric material of length L_{S}.

12. A high gradient multilayer vacuum insulator comprising:
a plurality of dielectric layers characterized by one of a lower relative permittivity and a higher relative permittivity and stacked in alternating arrangement so that the edges of said layers together form a vacuum-insulator interface.

13. A high gradient multi layer vacuum insulator comprising:
a dielectric cylinder having a curvilinear side surface which is a vacuum-insulator interface with grooves formed thereon in a direction substantially parallel to the cylinder ends to produce alternating grooves and lands with the lands having a higher relative permittivity than the space within the grooves.

14. The high gradient multilayer vacuum insulator of claim 13,
wherein the grooves and the lands have a 1:1 packing factor.

15. The high gradient multilayer vacuum insulator of claim 13,
wherein the grooves are formed continuously on the curvilinear side surface.

16. A high gradient multilayer vacuum insulator comprising:
a plurality of dielectric layers in stacked arrangement so that the edges of said layers together form a vacuum-insulator interface and outer edge surfaces of a first set of alternating layers are recessed from outer edge surfaces of a second set of alternating layers.
